(19) United States
(12) Patent Application Publication
(10) Pub. No.: US 2019/0140432 A1
(43) Pub. Date: May 9, 2019

(54) BENDABLE SERVICEHEAD ADAPTER

(71) Applicant: Chris R. Davis, SR., Haddonfield, NJ (US)

(72) Inventor: Chris R. Davis, SR., Haddonfield, NJ (US)

(21) Appl. No.: 16/185,440

(22) Filed: Nov. 9, 2018

Related U.S. Application Data
(60) Provisional application No. 62/583,864, filed on Nov. 9, 2017.

(51) Int. Cl. H02G 3/04; H02G 1/06

(52) U.S. Cl. CPC H02G 3/0456; H02G 7/05; H02G 1/06

(57) ABSTRACT

A bendable servicehead adapter is described. The bendable servicehead adapter includes a bendable body with an aperture formed therethrough and configured to guide an SEU cable therethrough, the bendable body having a first end and a second end. The bendable servicehead adapter also including a servicehead connector coupled to or integrated with the first end of the bendable body. The bendable servicehead adapter further includes a neutral wire slot formed in the bendable body and the servicehead connector proximate the first end of the bendable body

### REFERENCE TO RELATED APPLICATIONS

This application claims the benefit of U.S. Provisional Patent Application No. 62/583,864, filed on Nov. 9, 2017 to inventor Chris R. Davis Sr., entitled BENDABLE SERVICE HEAD ADAPTER, which is herein incorporated by reference in its entirety.

### BACKGROUND

Two spans of wire that provide electrical power (service) to a residential or small commercial customer are the utility service drop and the service entrance unarmored cable (often referred to as the SEU cable or the service entrance cable).

A utility service drop is an overhead electrical line running from a utility pole, to an electrical customer's home, building, or other premises. At or near the peak of a customer's roofline, there is a connection point where the electric utilities service drop meets a service entrance unarmored (SEU) cable to provide power to their customers. Conductors, of a service drop, are usually owned and maintained by the utility company, while the SEU is owned and maintained by the customer.

In North America and countries with similar systems, a 120/240 V split single phase system is used. A pole-mounted distribution transformer usually provides power for one or two residences. The service drop is made up of two 120 V lines and a neutral line. When these lines are insulated and twisted together, they are referred to as a triplex cable, which may contain a supporting messenger cable in the middle of the neutral conductor to provide strength for long spans. The neutral line, from the pole and then through the service entrance cable, is connected to separate earth grounds near the inside main service panel. The service drop provides the building with two 120 V lines of opposite phase, so 240 V can be obtained by connecting a load between the two 120 V conductors, while 120 V loads are connected between either of the two 120 V lines and the neutral line. 240 V circuits are used for high-power devices, such as air conditioners, clothes dryers, ovens and boilers, while 120 V circuits are used for lighter loads such as lighting and ordinary small appliance outlets.

At the point of attachment near the roofline of the customer's premises, the wires from the utility service drop are connected to a very stiff service entrance cable, which is fed through a weatherhead, or servicehead that protects against entry of rain and snow. The service entrance cable wire is then strapped down along the exterior wall.

The service entrance cable is then connected to an electric meter, which measures, and records the power used for billing purposes. From there, the SEU cable then enters the main service panel. Although the utility company owns and maintains the actual meter itself for billing purposes, the SEU cabling and the meter cabinet are owned and maintained by the customer. The service panel will contain a “main” fuse or circuit breaker, which controls all of the electric current entering the building at once, and a number of smaller fuses/breakers, which protect individual branch circuits. There is always a main shutoff switch to turn off all power; when circuit breakers are used this is provided by the main circuit breaker.

The weatherhead, also called a weathercap, service head, service entrance cap, or gooseneck (slang) is a weatherproof protection point for the transition from the overhead utility power wires to the service entrance cable running down a building, or where wires transition between overhead and underground cables. At the point of attachment along the roofline of a building, the SEU wires directly pass through the weatherhead, which is a waterproof cap that allows the wires to enter without letting in water. It is shaped like a hood over top of a bottom opening where the wires enter facing down at an angle of at least 45°, to shield them from precipitation. Before they enter the weatherhead, a drip loop is left in the overhead SEU wires, which permits rainwater that collects on the wires to drip off before reaching the weatherhead.

Weatherheads are required by electrical codes or building codes. They are also used on utility poles where overhead power lines enter a conduit to pass underground.

### SUMMARY

An exemplary embodiment relates to a bendable servicehead adapter. The bendable servicehead adapter includes a bendable body with an aperture formed therethrough and configured to guide an SEU cable therethrough, the bendable body having a first end and a second end. The bendable servicehead adapter also including a servicehead connector coupled to or integrated with the first end of the bendable body. The bendable servicehead adapter further includes a neutral wire slot formed in the bendable body and the servicehead connector proximate the first end of the bendable body.

Another exemplary embodiment relates to a bendable servicehead adapter. The bendable servicehead includes a bendable body with an aperture formed therethrough and configured to guide an SEU cable therethrough, the bendable body having a first end and a second end. The bendable servicehead adapter also including a swivel bracket having an upper portion and a lower portion, the upper portion being pivotally coupled to the lower portion, the upper portion having a mounting hole configured for mounting the bracket to a surface, the upper portion having an engagement portion for engaging with the bendable body proximate the first end, the lower portion having an engagement portion for engaging with the bendable body proximate the second end and the lower portion terminating at its lower end in an SEU clamp.

Yet another exemplary embodiment relates to a method of mounting an SEU cable to a servicehead. The method includes mounting a swivel bracket below a servicehead; providing a bendable servicehead adapter; threading the SEU cable through the bendable servicehead adapter and through the servicehead; and coupling the bendable servicehead adapter to the servicehead.

In addition to the foregoing, other system aspects are described in the claims, drawings, and text forming a part of the disclosure set forth herein. The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the disclosures set forth herein.

### BRIEF DESCRIPTION OF THE DRAWINGS

FIG. 1 is an example of a service entrance point at a customer's home.

FIG. 2 is an example of an installation, which is illegal, suboptimal, or violates electrical codes (national and/or local).

FIG. 3 is an exemplary installation of a service drop that is not vertically aligned with the location of the electrical service meter box.

FIG. 4 is an exemplary embodiment of a servicehead coupled to an exemplary embodiment of a bendable servicehead adapter.

FIG. 5 is an exemplary embodiment of a front, side, and overhead view of a bendable servicehead adapter.

FIG. 6 is an exemplary embodiment of a pivoting bracket.

FIG. 7 is a side view of the pivoting bracket depicted in FIG. 6.

The use of the same symbols in different drawings typically indicates similar or identical items unless context dictates otherwise.

### DETAILED DESCRIPTION

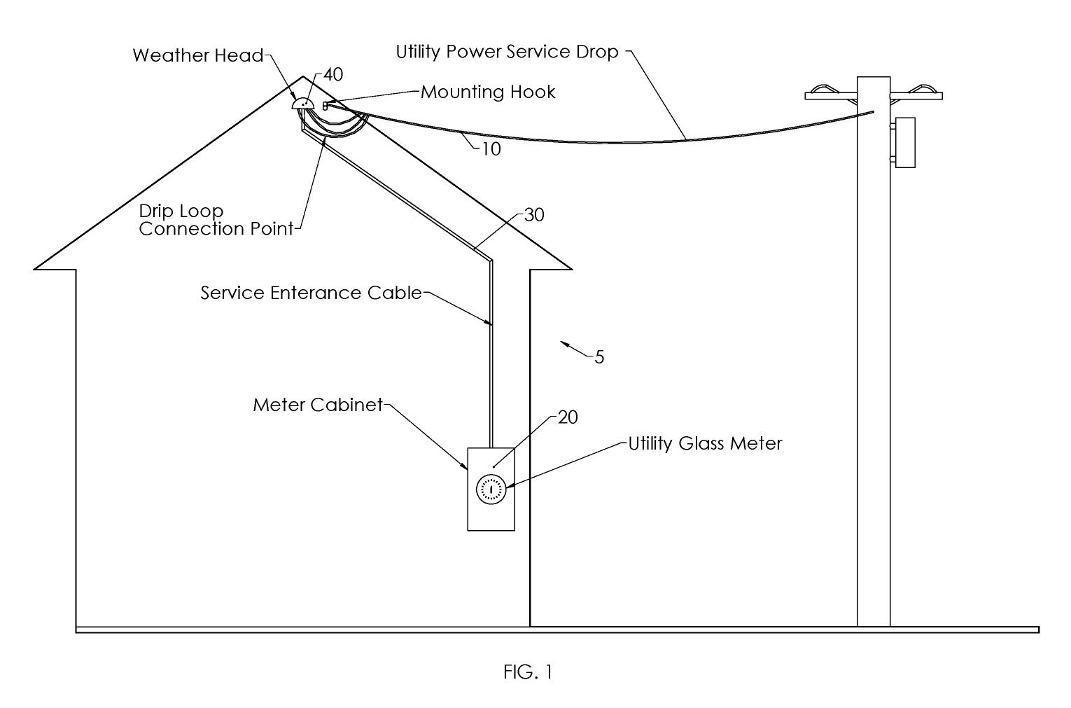

Referring to FIG. 1, an example 5 of a service entrance point at a customer's home or the like, is depicted. The service entrance points include a service drop 10 and a service meter box 20. Service meter 20 receives electricity from service drop 10. In the case of system 5 service meter 20 receives electricity from service drop 10 through an SEU cable 30 which is coupled to the side of the house by straps In system 5, service drops 10 is connected to SEU cable 30 through servicehead or weatherhead 40. When an installer of the electrical service comes to a home, it might be necessary to install weatherhead 40, and SEU cable 30 to the service meter box 20.

If the location of the service drop and weatherhead are vertically aligned, the installation is relatively straightforward. If however, the service drop location and the service meter box are not vertically aligned, installation is much more difficult.

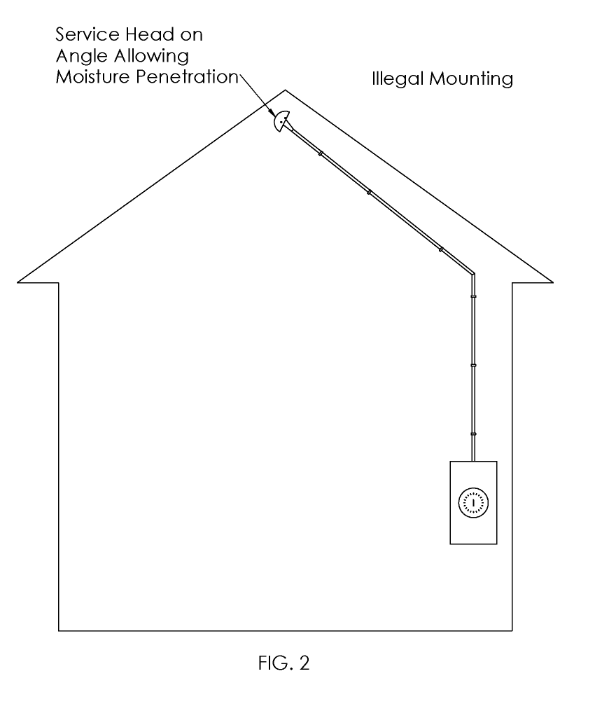

Referring to FIG. 2, an example of an installation, which is illegal, suboptimal, or violates electrical codes (national and/or local), is depicted. This installation results from a situation in which the location of the service drop is not vertically aligned with the electrical service meter box. FIG. 2 depicts a situation where the servicehead is installed at an angle. This configuration violates most electrical codes. As well, this installation is suboptimal because it is more likely to allow the ingress of water into the servicehead during periods of wind and rain. When water gets into the servicehead, water may then enter the SEU cable outer jacket and may have the potential to cause a variety of problems with the electrical system. Thus, it is not desirable to have an installations as depicted in FIG. 2.

Because the SEU cable is extremely stiff and difficult to bend during installation, installers have a difficult time installing the servicehead in its proper upright orientation when the service drop and the service meter box are not vertically aligned. It would be extremely desirable for installers to have a solution which would provide ease of installation for aligning the service head in an upright orientation. Up until now, no such solution exists.

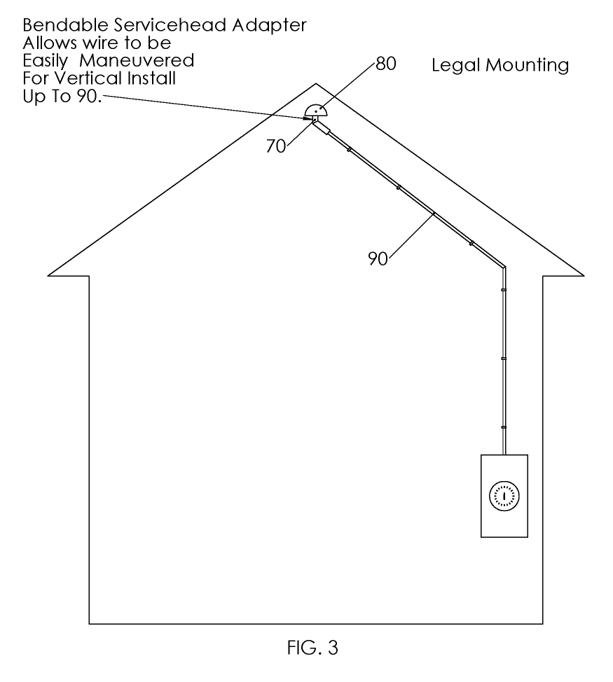

Referring to FIG. 3, an installation situation is depicted in which the location of the service drop is not vertically aligned with the location of the electrical service meter box. In this configuration, a bendable servicehead adapter, in accordance with an exemplary embodiment of the invention, is used to allow the servicehead to be positioned in an upright orientation. The upright orientation provides an optimal orientation and/or compliance with local and federal building codes. The bendable adapter 70 is coupled, at one end, to servicehead 80 and on the other end to SEU cable 90. In an exemplary embodiment, bendable adapter 70 allow an installer to thread the SEU cable 90 through bendable adapter 70 in a straight configuration. Next, adapter 70 can be bent to the desired orientation and attached to a bracket that is affixed to the wall and allows for the bend of the cable inside the adapter to maintain a bent configuration. Service head 80 is then attached to bendable adapter 70 and affixed to a mounting bracket that is coupled to the wall. Servicehead 80 is maintained in an upright orientation in compliance with many local and federal building codes.

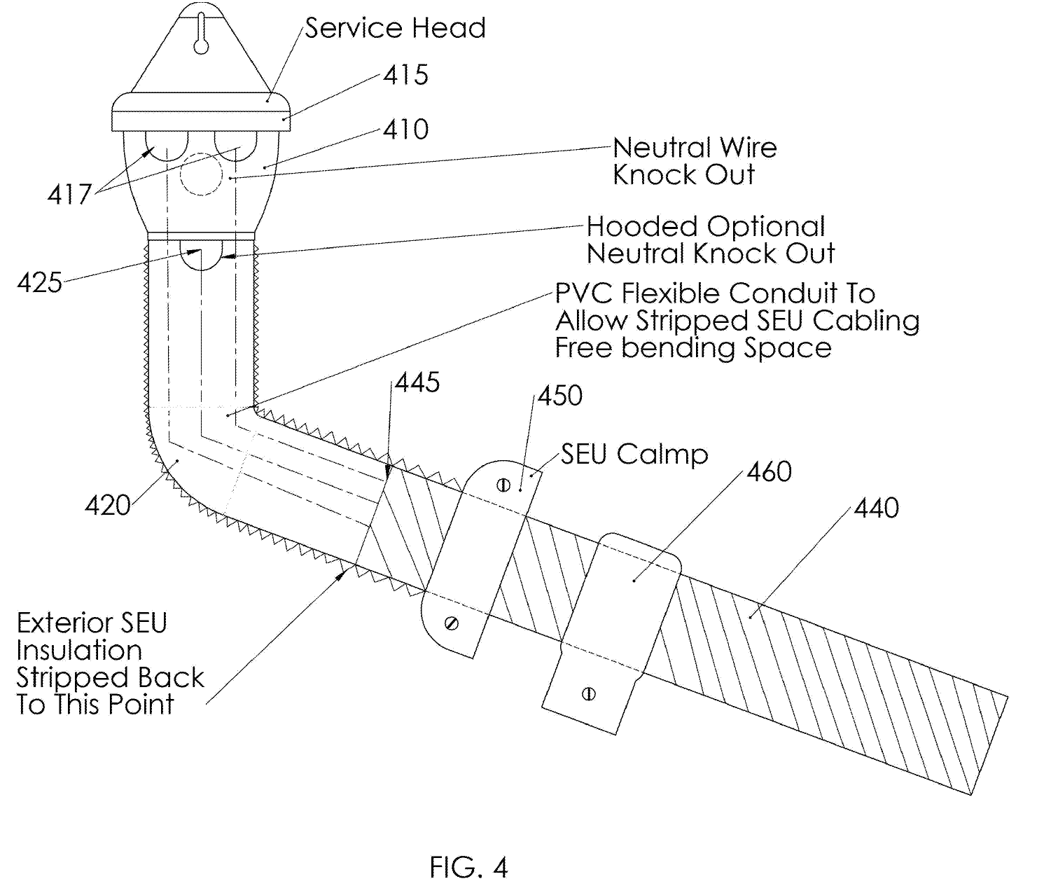

Referring now to FIG. 4, a servicehead 410 is coupled to an exemplary embodiment of a bendable servicehead adapter 420 (the combination colloquially referred to as “Service Head”). Servicehead 410 includes a servicehead cap 415 which, when maintained in the upright position prevents water from rain and the like from making ingress in to the interior of the service head and subsequently into the casing of SEU cable 440. Servicehead 410 includes apertures 417 through which conductors from SEU cable 440 are threaded to be coupled to the service drop. Servicehead 410 may also include a knock out for a neutral conductor of SEU cable 440. Without the use of bendable adapter 420, SEU cable 440 is very difficult to bend when the outer insulation of the cable is in place. Use of bendable adapter 420 allows the insulation to be stripped back further to the point 445 as depicted in FIG. 4. An SEU clamp 450 couples bendable adapter 420 to SEU cable 440. Strap 460 couples SEU cable 440 to the building wall. In an exemplary embodiment, bendable adapter 420 may include a hooded knock out 425 for the neutral conductor of SEU cable 440. Bendable adapter 420 may be constructed from a variety of materials including plastics, polymers, rubber, etc. In one exemplary embodiment, bendable adapter 420 may be constructed from injection molded polyvinyl chloride (PVC). The bendability may be achieved by being molded in a corrugated form. It may also be possible to form bendable adapter 420 with other mechanical configurations which enable the bendability without departing from the scope of the invention.

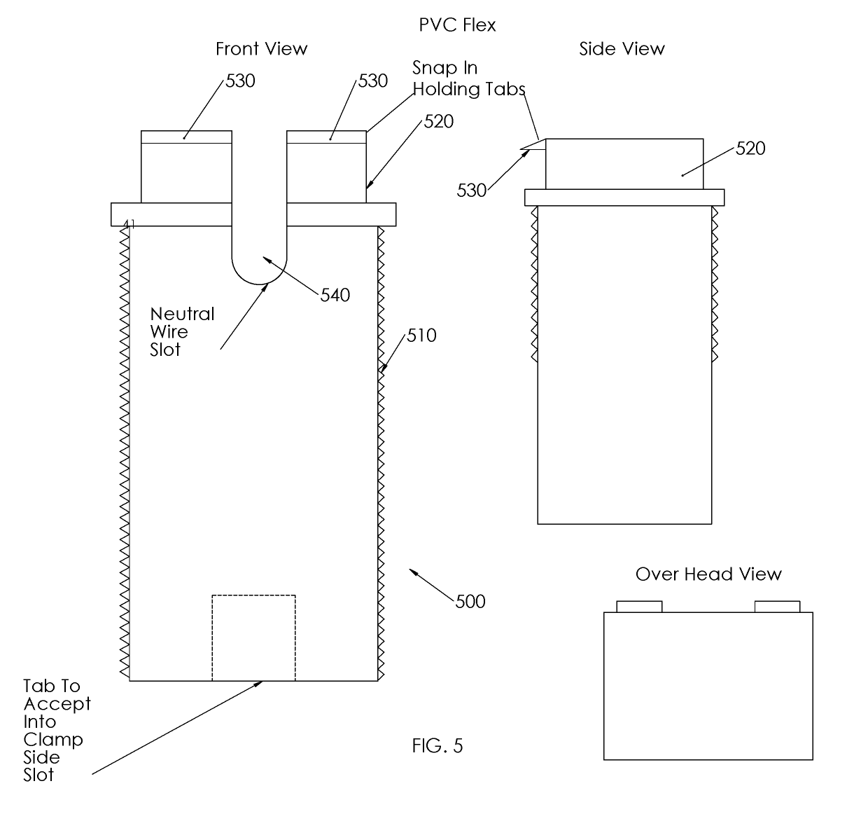

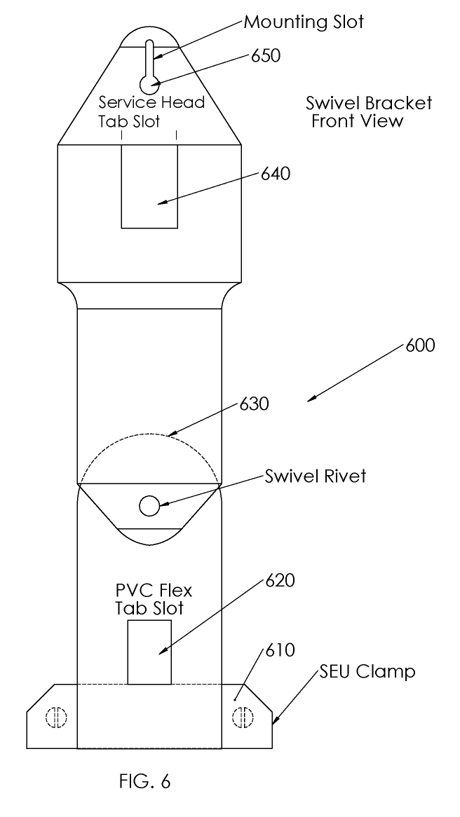

Referring to FIG. 5, a front, side, and overhead view of a bendable adapter 500 in accordance with an exemplary embodiment of the invention, is depicted. Bendable adapter 500 is formed from flexible PVC with a corrugated side 510. An engagement area 520 is to engage with a servicehead. Snap in holding tabs 530 provide for enhanced frictional engagement with the servicehead. In an exemplary embodiment, bendable adapter 500 include a slot 540 for running the neutral conductor therethrough. In some exemplary embodiments, bendable adapter 510 may include a tab or indentation to engage with and accept a bracket which mounts the bendable adapter to a building wall. For example, in FIG. 6, a pivoting bracket 600 would suffice to engage with bendable adapter 420. In accordance with an exemplary embodiment, pivoting bracket 600 includes an SEU clamp 610 that is coupled to the SEU cable.

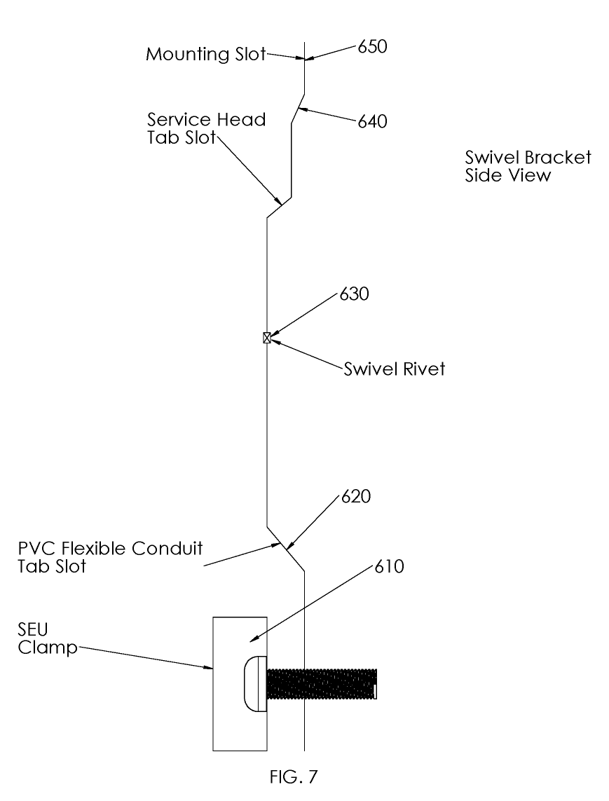

Bracket 600 also includes a flex tab slot 620 for engaging the bendable adapter. Pivoting bracket 600 includes a pivoting joint or swivel rivet 630 which allows the two portions of the bracket to pivot relative to one another. At the upper end, bracket 600 includes a servicehead tab slot 640 for engaging with the servicehead tab. Bracket 600 may be mounted, using SEU clamp 610 and mounting slot 650, to a building wall to hold the servicehead and the cable thereto. Bracket 600 may be pivoted to any relative angle and allows the bendable adapter to maintain its shape during non-stop usage. FIG. 7 depicts a side view of the mounting bracket 600 depicted in FIG. 6.

An exemplary embodiment of a flexible servichead adapter is disclosed. The adapter includes a bendable body. The adapter also includes a servicehead engagement structure as well as a mounting bracket engagement area. The bendable body includes an interior aperture which extends through the bendable body. A pivotable mounting bracket is used to mount the bendable body to a building wall or other surface.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

What is claimed is:

1. A bendable servicehead adapter, comprising:
a bendable body with an aperture formed therethrough and configured to guide an SEU cable therethrough, the bendable body having a first end and a second end;
a servicehead connector coupled to or integrated with the first end of the bendable body; and
a neutral wire slot formed in the bendable body and the servicehead connector proximate the first end of the bendable body.

2. The bendable servicehead adapter of claim 1, wherein the body comprises a flexible PVC.

3. The bendable servicehead adapter of claim 1, wherein the body comprises a flexible PVC and the flexible PVC is at least partially corrugated.

4. The bendable servicehead adapter of claim 1, wherein the servicehead connector comprises a frictional fit connector.

5. The bendable servicehead adapter of claim 1, wherein the servicehead connector comprises a snap-in connector.

6. The bendable servicehead adapter of claim 1, further comprising:
a bracket coupler formed in the bendable body and configured for engagement with an a mounting bracket.

7. The bendable servicehead adapter of claim 6, wherein the bracket coupler includes an indentation or a tab formed proximate the second end of the bendable body.

8. The bendable servicehead adapter of claim 1, further comprising:
an SEU clamp engaging the bendable body proximate the second end.

9. A bendable servicehead adapter, comprising:
a bendable body with an aperture formed therethrough and configured to guide an SEU cable therethrough, the bendable body having a first end and a second end;
a swivel bracket having an upper portion and a lower portion, the upper portion being pivotally coupled to the lower portion, the upper portion having a mounting hole configured for mounting the bracket to a surface, the upper portion having an engagement portion for engaging with the bendable body proximate the first end, the lower portion having an engagement portion for engaging with the bendable body proximate the second end and the lower portion terminating at its lower end in an SEU clamp.

10. The bendable servicehead adapter of claim 9, wherein the body comprises a flexible PVC.

11. The bendable servicehead adapter of claim 9, wherein the body comprises a flexible PVC and the flexible PVC is at least partially corrugated.

12. The bendable servicehead adapter of claim 9, wherein the bendable body includes a servicehead connector and the servicehead connector comprises a frictional fit connector.

13. The bendable servicehead adapter of claim 9, wherein the bendable body includes a servicehead connector and the servicehead connector comprises a snap-in connector.

14. The bendable servicehead adapter of claim 9, further comprising:
a bracket coupler formed in the bendable body and configured for engagement it the swivel bracket.

15. The bendable servicehead adapter of claim 14, wherein the bracket coupler includes an indentation or a tab formed proximate the second end of the bendable body.

16. A method of mounting an SEU cable to a servicehead comprising:
mounting a swivel bracket below a servicehead;
providing a bendable servicehead adapter;
threading the SEU cable through the bendable servicehead adapter and through the servicehead; and
coupling the bendable servicehead adapter to the servicehead.

17. The method of claim 16, further comprising:
coupling the bendable servicehead adapter to the swivel bracket.

18. The method of claim 16, further comprising:
providing an SEU clamp.

19. The method of claim 18, further comprising:
clamping the SEU clamp to the SEU Cable.

20. The method of claim 16, further comprising:
coupling the SEU cable to a service drop.
